(19) United States
(12) Patent Application Publication
(10) Pub. No.: US 2006/0177288 A1
(43) Pub. Date: Aug. 10, 2006

(54) Multiple loadlocks and processing chamber

(76) Inventors: N. William Parker, Pleasanton, CA (US); S. Daniel Miller, Gilroy, CA (US); Tirunelveli S. Ravi, San Jose, CA (US)

Correspondence Address: PILLSBURY WINTHROP SHAW PITTMAN LLP, P.O. BOX 10500, MCLEAN, VA, 22102, US

(21) Appl. No.: 11/054,932

(22) Filed: Feb. 9, 2005

(51) Int. Cl. B65G 1/00

(52) U.S. Cl. 414/217

(57) ABSTRACT

A system for the processing of large substrates such as those employed in the manufacture of flat panel displays is disclosed. In a first embodiment, a loadlock assembly, comprising two loadlock chambers configured to accommodate a multiplicity of large substrates, is coupled to a processing chamber with an input/output port. The processing chamber and the loadlock assembly are configured to move relative to each other to allow positioning of: either of the two loadlock chambers with said port; and any one of the multiplicity of large substrates for passage through the port. In a second embodiment, input and output loadlock assemblies, each comprising two loadlock chambers, are coupled to a dual-ported processing chamber in a pass-through configuration, wherein the input and output loadlock assemblies each move independently relative to the processing chamber.

### BACKGROUND OF THE INVENTION

1. Fields of Use for the Invention

This invention relates to the field of systems for the processing of large substrates such as those used in the manufacture of flat panel displays, and in particular to loadlocks.

2. Description of the Related Art

During the manufacture of flat panel displays, such as liquid crystal displays (LCDs), for many early steps, the circuitry for the displays is formed on the surface of a large substrate, often containing six or more displays in progress. Typically, many of the manufacturing steps for LCDs require the use of vacuum processing. Due to the large sizes of the LCD substrates during manufacture (>2 m×2 m), correspondingly large vacuum systems are required. A common method for introducing substrates into a vacuum system is the use of “loadlocks”, which are additional chambers (one or more) attached to the main processing chamber. The loadlocks have two valves, one which opens to allow introduction of the substrate into the loadlock from outside of the processing tool, and a second valve which opens to allow the substrate to be transferred from the loadlock into the processing chamber. This methodology is familiar to those skilled in the art. The times required to vent and pump the loadlock are both generally proportional to the internal volume of the loadlock, which is, in turn, determined by the area of the substrate. Thus, very large substrates may require long vent and pump times, exceeding the time required to process a single substrate.

In the processing of semiconductor wafers, which are ≦300 mm in diameter, a cluster tool configuration is typically used, wherein dual loadlocks are mounted side-by-side, attached to a chamber containing a wafer-transfer robot. While one loadlock is undergoing a vent/exchange/pumpdown cycle, the other loadlock is at vacuum. Each of the loadlocks holds a large number of wafers, up to 25 each. Insertion of wafers from the loadlock which is not undergoing the vent/exchange/pumpdown cycle is accomplished using the robot, which removes and replaces wafers individually into and out of slots, typically in a cassette. The problem with applying this approach to the processing of very large substrates such as those used for FPD fabrication is that it is impossible to use in-vacuum robotics without making the overall tool footprint excessively large and expensive. In conclusion, there is a need for a tool design with a smaller footprint; further, there is a need for a tool design without a vacuum robot; furthermore, there is a need for a tool design and mode of operation which is lower cost.

### SUMMARY OF THE INVENTION

A system comprising multiple loadlocks and a processing chamber which enables high throughput processing of large substrates is disclosed herein. In a first embodiment, the system comprises: a processing chamber including a port configured to accommodate passage of one large substrate at a time; and a loadlock assembly coupled to the processing chamber, configured to accommodate a multiplicity of large substrates. The loadlock assembly and the processing chamber are configured to move relative to each other to allow positioning of any one of the large substrates for passage through the port. The loadlock assembly comprises a multiplicity of loadlock chambers, wherein the loadlock assembly and the processing chamber are configured to move relative to each other to allow alignment of any one of the multiplicity of loadlock chambers with the port.

The system can be a vacuum system, in which case it has the advantage of being able to match the loadlock turn-around time (comprising venting, substrate exchange, and pumpdown) to the processing time for one or more large substrates. For example, a vacuum system is used for electron-beam testing for electrical defects of flat panel display (FPD) substrates, wherein a linear array of electron columns simultaneously directs a plurality of electron beams onto the surface of an FPD substrate under test. Each electron beam is used to test the electrical functionality of individual pixels within the displays being manufactured on the substrate. Typically, the testing time for a Gen-8 LCD substrate is 40 s when employing a multiple column assembly 104 (see FIG. 1), as disclosed in U.S. Provisional Patent Application No. 60/608,609. Combined with substrate insertion and removal from the processing chamber 102 where electrical testing of the substrate is performed, the total time to test an LCD substrate may be 60 s. If the loadlock vent, substrate exchange and pumpdown process can be performed in parallel with substrate electrical testing, then the maximum throughput can be achieved. Throughput is the inverse of the turn around cycle time (TACT), where a 60 s TACT corresponds to 60 substrates/hour, while a 120 s TACT gives only 30 substrates/hour. The difficulty generally encountered in doing the loadlock vent, exchange and pumpdown cycle in parallel with electrical testing is that the total time for this cycle can exceed 60 s, thereby limiting the achievable tool throughput.

The present invention provides a means for achieving minimum TACTs, independent of the loadlock cycle time, T_{Loadlock}, and determined only by the substrate testing time, T_{Testing}. T_{Loadlock} is the total time for the following four steps:
1. Venting the loadlock to atmospheric pressure (usually with dry nitrogen).
2. Removal of the N substrates just tested from the loadlock.
3. Insertion of N substrates to be tested into the loadlock.
4. Pumping the loadlock down to the testing chamber vacuum level.
   Note that steps (2) and (3) may be performed serially or in parallel. The substrate testing time, T_{Testing}, is the total time for:
1. Substrate insertion into the testing chamber from the loadlock.
2. Alignment of the substrate to the electron optical column assembly.
3. Electron-beam testing of all pixels on the substrate.
4. Replacement of the (tested) substrate back into the loadlock.

The loadlock of the present invention comprises two chambers, each containing N substrates, where N≡T_{Loadlock}/T_{Testing} (rounded up if T_{Loadlock}/T_{Testing} is not an integer). If T_{Loadlock}=N T_{Testing} (i.e., no rounding up was necessary), then the loadlock vent/exchange/pump cycle is completed at the same time that testing of the N-th substrate is completed. If T_{Loadlock}<N T_{Testing} (i.e., N was rounded up), then the loadlock vent/exchange/pump cycle is completed before testing of the N-th substrate is completed. In either case (rounding up or no rounding up of N), the system never waits for the completion of the loadlock vent/exchange/pumpdown cycle and throughput is determined solely by T_{Testing}.

During the first half of the overall vacuum system cycle:
1. Loadlock chamber #1 is indexed to the opening in the processing chamber, enabling the four steps outlined above for T_{Testing} to be performed for each of the N substrates sequentially.
2. Loadlock chamber #2 is performing the four steps outlined above for T_{Loadlock} to be performed.
   When all N substrates in loadlock chamber #1 have been tested (requiring a time N T_{Testing}), loadlock chamber #2 has already completed its cycle (since T_{Loadlock}≦N T_{Testing}, given the above definition of N). At this point, the second half of the overall vacuum system cycle begins:
1. Loadlock chamber #1 is performing the four steps outlined above for T_{Loadlock} to be performed.
2. The loadlock assembly (comprising both loadlock chambers #1 and #2) moves vertically to index loadlock chamber #2 to the opening in the processing chamber, enabling the four steps outlined above for T_{Testing} to be performed for each of the N substrates sequentially.
   In a second embodiment of the present invention, the processing chamber is configured with two ports, one for substrate insertion and the other for substrate removal. A loadlock assembly is interfaced to each of these ports, allowing substrate processing in a “pass-through” configuration. The operation of each loadlock assembly is very similar to that of the single loadlock assembly described above. This has the advantage of a somewhat reduced TACT of 50s (assuming same as in the example given above, but with 2 loadlock assemblies in a pass-through configuration).

### BRIEF DESCRIPTION OF THE FIGURES

FIG. 1 shows a schematic of a cross-section in a vertical plane of a dual loadlock and processing chamber at time=0 s in the operational cycle.

FIG. 2 shows a schematic of a cross-section in a vertical plane of a dual loadlock and processing chamber at time=4 s in the operational cycle.

FIG. 3 shows a schematic of a cross-section in a vertical plane of a dual loadlock and processing chamber at time=21 s in the operational cycle.

FIG. 4 shows a schematic of a cross-section in a vertical plane of a dual loadlock and processing chamber at time=30 s in the operational cycle.

FIG. 5 shows a schematic of a cross-section in a vertical plane of a dual loadlock and processing chamber at time=35 s in the operational cycle.

FIG. 6 shows a schematic of a cross-section in a vertical plane of a dual loadlock and processing chamber at time=45 s in the operational cycle.

FIG. 7A shows a schematic of a cross-section in a vertical plane of a dual loadlock and processing chamber at time=52 s in the operational cycle.

FIG. 7B shows a schematic of a cross-section in the horizontal plane containing A-A of the dual loadlock and processing chamber of FIG. 7A.

FIG. 8 shows a schematic of a cross-section in a vertical plane of a dual loadlock and processing chamber at time=57 s in the operational cycle.

FIG. 9 shows a schematic of a cross-section in a vertical plane of a dual loadlock and processing chamber at time=90 s in the operational cycle.

FIG. 10 shows a schematic of a cross-section in a vertical plane of a dual loadlock and processing chamber at time=110 s in the operational cycle.

FIG. 11A shows a schematic of a cross-section in a vertical plane of a dual loadlock and processing chamber at time=117 s in the operational cycle.

FIG. 11B shows a schematic of a cross-section in a vertical plane of the moving vacuum seal of the dual loadlock and processing chamber of FIG. 11A.

FIG. 11C is an end view of the loadlock assembly of FIG. 11B, showing the surface facing towards the processing chamber.

FIG. 11D is an end view of the processing chamber of FIG. 11B, showing the surface facing towards the loadlock assembly.

FIG. 12 shows a schematic of a cross-section in a vertical plane of a bellows-sealed moving vacuum seal between the dual loadlock and the processing chamber.

FIG. 13 shows a schematic of a cross-section in a vertical plane of a dual loadlock and processing chamber at time=124 s in the operational cycle.

FIG. 14 shows a schematic of a cross-section in a vertical plane of a dual loadlock and processing chamber at time=155 s in the operational cycle.

FIG. 15 shows a schematic of a cross-section in a vertical plane of a dual loadlock and processing chamber at time=165 s in the operational cycle.

FIG. 16 shows a schematic of a cross-section in a vertical plane of a dual loadlock and processing chamber at time=177 s in the operational cycle.

FIG. 17 shows a schematic of a cross-section in a vertical plane of a dual loadlock and processing chamber at time=230 s in the operational cycle.

FIG. 18 shows a schematic of a cross-section in a vertical plane of a dual loadlock and processing chamber at time=237 s in the operational cycle.

FIG. 19 shows an operational cycle timing diagram for a dual loadlock and processing chamber vacuum system.

FIG. 20 shows an operational cycle timing diagram for a second embodiment of the present invention, comprising two dual loadlocks and a processing chamber.

FIG. 21 shows a schematic of a cross-section in a vertical plane of two dual loadlocks and processing chamber at time=0 s in the operational cycle.

FIG. 22 shows a schematic of a cross-section in a vertical plane of two dual loadlocks and processing chamber at time=25 s in the operational cycle.

FIG. 23 shows a schematic of a cross-section in a vertical plane of two dual loadlocks and processing chamber at time=125 s in the operational cycle.

### DETAILED DESCRIPTION

This invention will be discussed in detail using its implementation in the field of LCD substrate testing using multiple electron beams as an illustrative example. However, many other fields of use are envisaged, such as electron beam testing of optical light emitting displays, direct-write multiple electron beam lithography for FPD substrate patterning, thin-film deposition on large area substrates such as FPD substrates, etc.

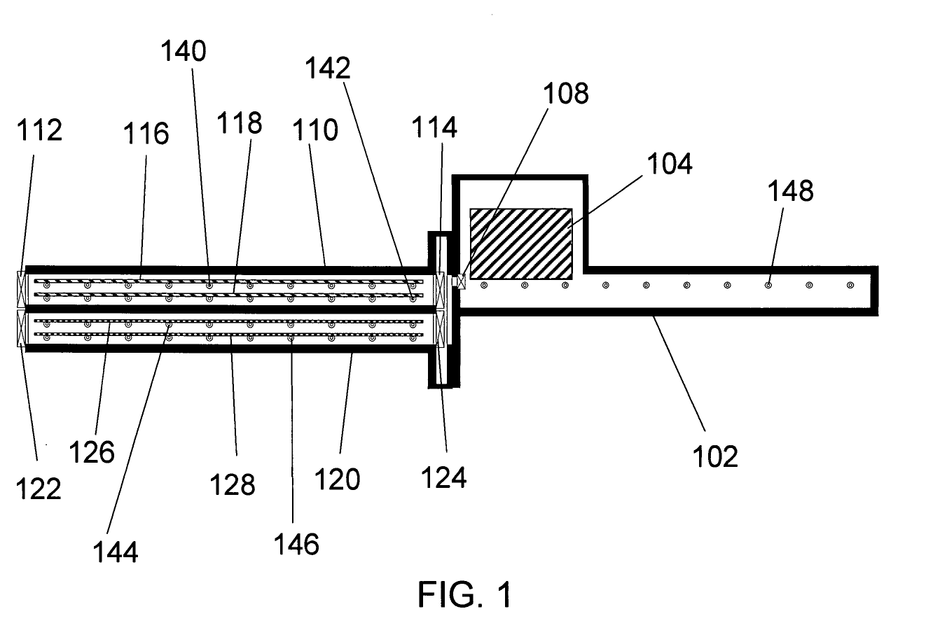

FIGS. 1 through 18 show cross-sectional schematic views of a first embodiment of the present invention comprising dual loadlocks and a processing chamber. The vacuum system is illustrated at various times in the operational cycle. During the operational cycle shown here, a total of four substrates 116, 118, 426, and 428 are tested using electron beams generated by the column assembly 104, mounted in the processing chamber 102. At the left of processing chamber 102 in FIGS. 1 through 18 is the loadlock assembly, comprising loadlock chambers #1 110 and #2 120, external valves 112 and 122, internal valves 114 and 124, and rollers 140, 142, 144, and 146.

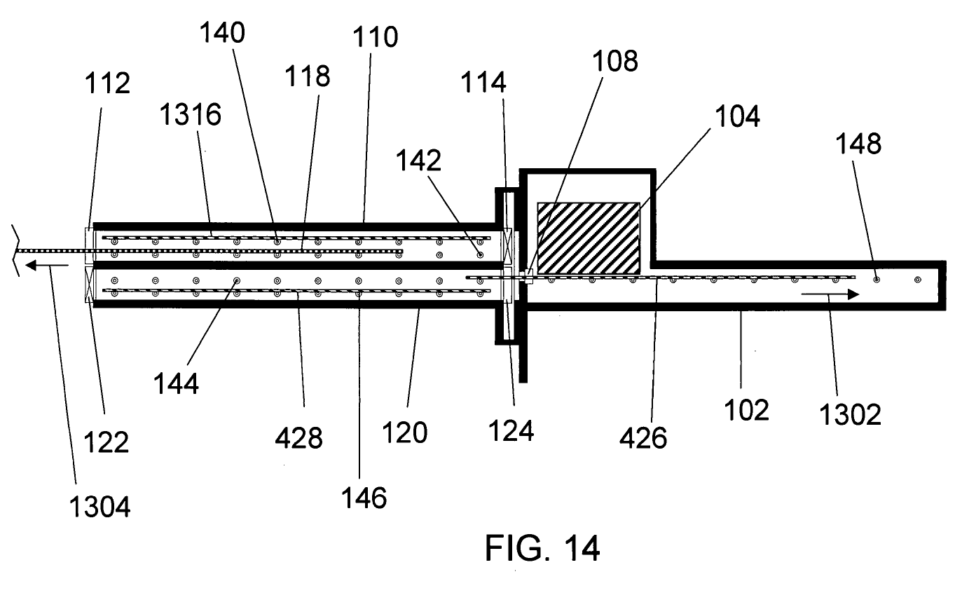

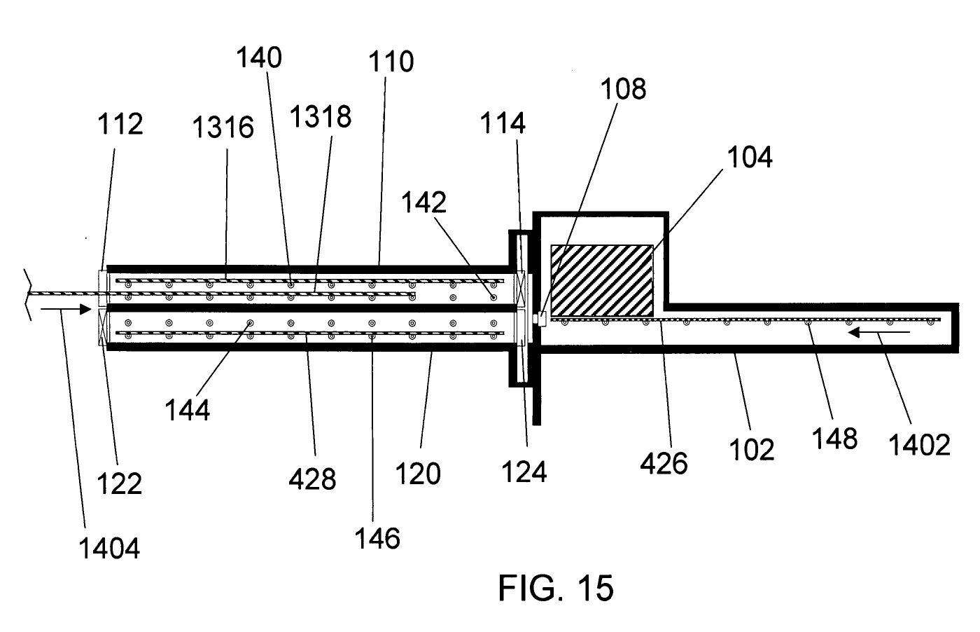

Substrates located outside the vacuum system are inserted into or removed from loadlock chamber #1 110 through external valve 112. Substrates located in loadlock chamber #1 110 are inserted into or removed from processing chamber 102 through internal valve 114. Substrates being inserted into or removed from the upper slot of loadlock chamber #1 110,. such as substrate 116 in FIG. 1 or substrate 1316 in FIG. 14, are supported and moved by rollers 140, driven by bidirectional motors (not shown). Substrates being inserted into or removed from the lower slot of loadlock chamber #1 110, such as substrate 118 in FIG. 1 or substrate 1318 in FIG. 15, are supported and moved by rollers 142 driven by bi-directional motors (not shown).

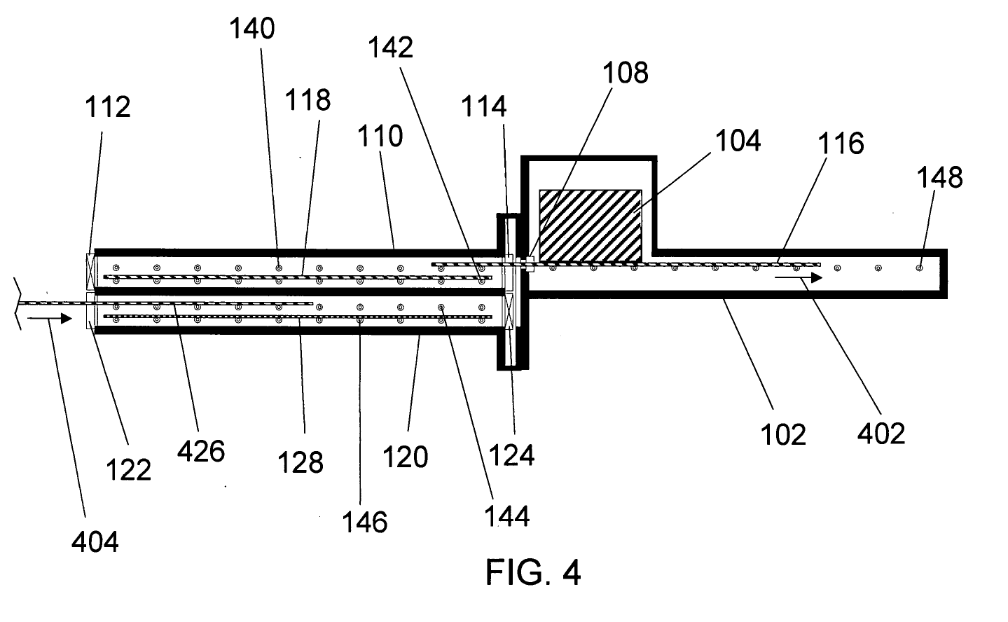

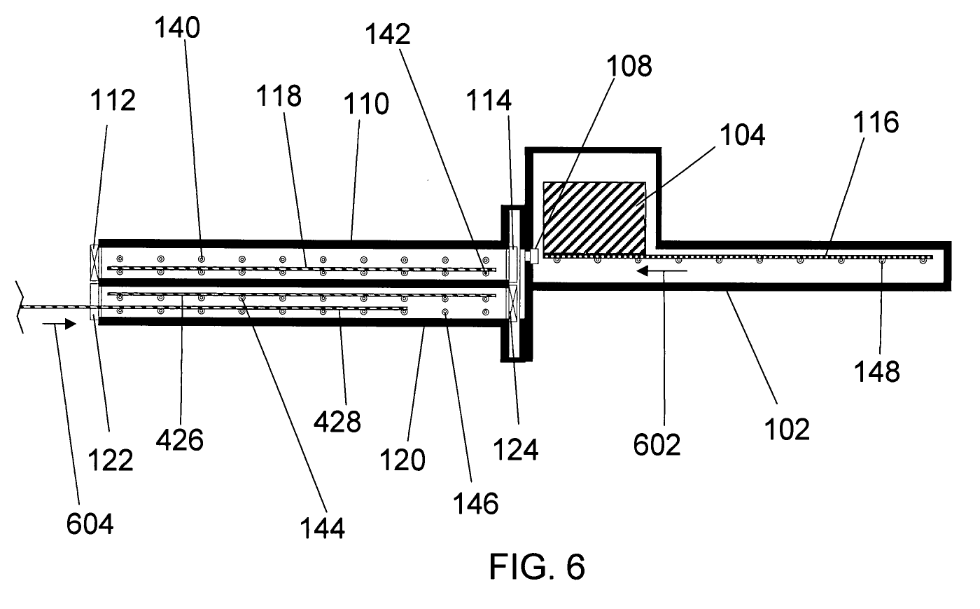

Substrates located outside the vacuum system are inserted into or removed from loadlock chamber #2 120 through external valve 122. Substrates located in loadlock chamber #2 120 are inserted into or removed from processing chamber 102 through internal valve 124. Substrates being inserted into or removed from the upper slot of loadlock chamber #2 120, such as substrate 126 in FIG. 1 or substrate 426 in FIG. 4, are supported and moved by rollers 144, driven by bi-directional motors (not shown). Substrates being inserted into or removed from the lower slot of loadlock chamber #2 120, such as substrate 128 in FIG. 1 or substrate 428 in FIG. 6, are supported and moved by rollers 146 driven by bidirectional motors (not shown).

An optional processing chamber seal-off valve 108 allows processing chamber 102 to be isolated from the loadlock assembly. In FIGS. 1 through 18, substrates which have not been tested yet are shown with widely-spaced angled cross-hatching, for example, substrates 116 and 118 in FIG. 1, while substrates which have already been tested are shown with narrowly-spaced vertical cross-hatching, for example, substrates 126 and 128 in FIG. 1.

The dual loadlock and processing chamber vacuum system may alternatively be used for other processes required during the manufacturing and testing of FPD substrates, including direct-write electron-beam lithography for patterning the FPD substrates and thin-film deposition of insulating or conducting materials onto the surfaces of FPD substrates. In addition, substrates for various types of flat panel displays may be processed, including liquid crystal displays (LCDs), optical light-emitting diode displays (OLEDs), plasma displays, etc. For each of these applications, the details of the processing chamber will differ, however, the overall dual loadlock and processing chamber concept would remain the same. For example, in a direct-write lithographic system employing the present invention, the processing chamber 102 would contain a column assembly designed to produce an array of small high current density electron beams. These electron beams would be individually turned on and off to expose patterns in a resist material on the surface of the FPD substrate in a manner familiar to those skilled in the art. Another example would be thin-film deposition onto the surface of an FPD substrate—in this case, the processing chamber 102 would contain a smaller internal vacuum chamber configured to generate and confine a high density plasma. This plasma could be used either in a process of plasma-enhanced chemical vapor deposition (PECVD) or in a process of physical vapor deposition (sputtering).

Examples of column assemblies that could be used for lithography are described in U.S. patent application Ser. No. 10/962,049 to N. William Parker filed 7 Oct. 2004, incorporated by reference herein. Examples of column assemblies that could be used for FPD inspection are described in US provisional patent application No. 60/608,609 to N. William Parker filed 10 Sep. 2004, incorporated by reference herein.

FIG. 1 shows the vacuum system of the present invention at Time 0 s, i.e., at the start of a 240 s total operational cycle time. Within loadlock chamber #1 110, two substrates 116 and 118 are shown, in the upper and lower slots, respectively. Within loadlock chamber #2 120, two substrates 126 and 128 are shown, in the upper and lower slots, respectively. All five valves 112, 114, 122, 124, and 108 are initially closed (closed valves are shown schematically with an “X” inside the rectangular valve profile). Substrates 116 and 118 in loadlock chamber #1 110 have not yet been tested, while substrates 126 and 128 in loadlock chamber #2 120 have already been tested. The loadlock assembly is positioned to index the upper slot in loadlock chamber #1 110 with the processing chamber 102, i.e., the upper slot in loadlock chamber #1 110 is aligned so that substrate 116 can move into the processing chamber 102 horizontally so that it is properly positioned under the column assembly 104 for electron-beam testing.

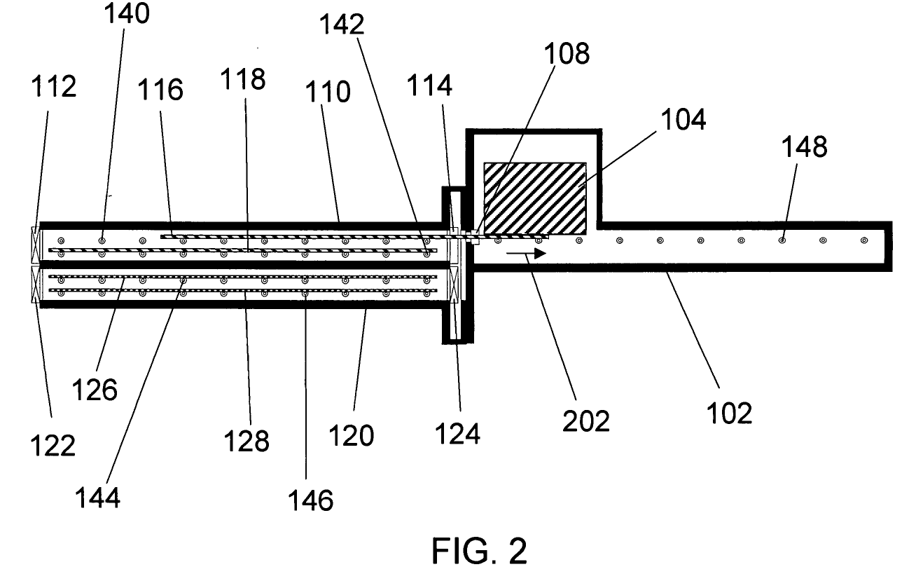

FIG. 2 shows the vacuum system at Time=4 s into the 240 s total operational cycle time. Valves 108 and 114 have opened to allow substrate 116 to be inserted (arrow 202) into processing chamber 102 from loadlock chamber #1 110 by rollers 148, working in synchronism with rollers 140. Rollers 148 are driven by bidirectional motors (not shown). Opened valves are shown schematically by the absence of an “X” inside the rectangular valve profile, for example valve 114 in FIG. 2. Loadlock chamber #2 120 is venting to atmospheric pressure (vent valves not shown).

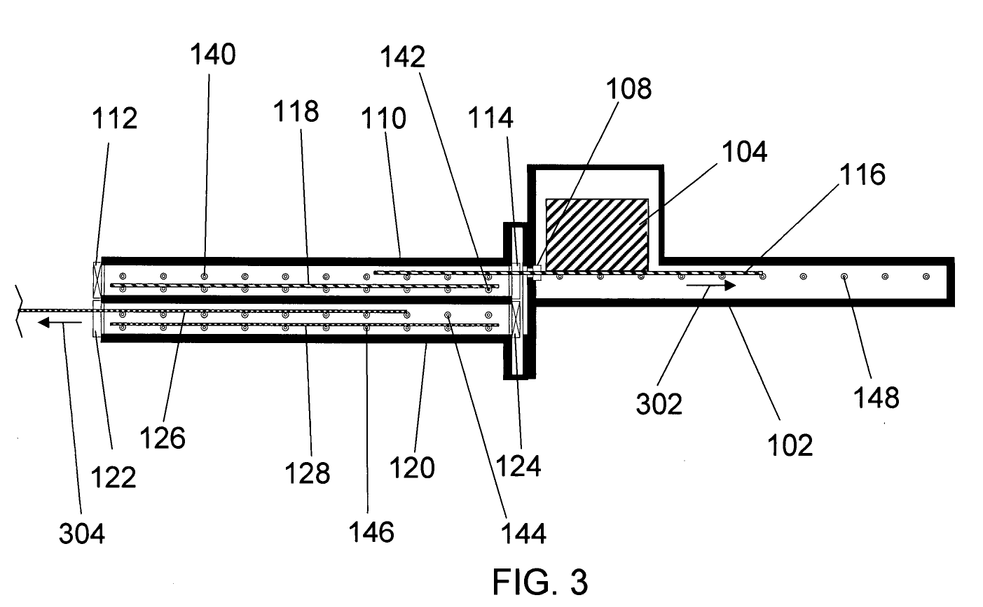

FIG. 3 shows the vacuum system at Time=21 s into the 240 s total operational cycle time. Substrate 116 is now being tested by the array of electron beams generated by column assembly 104. During testing, substrate 116 continues to move (arrow 302) into processing chamber 102—typically the speed of substrate 116 during testing would be lower than the speed of substrate 116 during insertion into processing chamber #1 102 (arrow 202 in FIG. 2). Column assembly 104 is positioned near the entrance of processing chamber 102 so that testing of substrate 116 can begin while substrate 116 is still being removed from loadlock chamber #1 110—this configuration minimizes the required footprint for a tool employing the vacuum system of the present invention. Loadlock chamber #2 120 has now been vented to atmospheric pressure, allowing valve 122 to open and substrate 126 (which has already been tested) to be removed (arrow 304) from the upper slot in loadlock chamber #2 120.

FIG. 4 shows the vacuum system at Time=30 s into the 240 s total operational cycle time. Substrate 116 is still being tested by column assembly 104 while moving (arrow 402) into processing chamber 102. Typically, the substrate speed will be constant during the entire testing process. Substrate 126 has been fully removed from the upper slot in loadlock chamber #2 120, leaving room for substrate 426 (which has not yet been tested) to be inserted (arrow 404) through open valve 122.

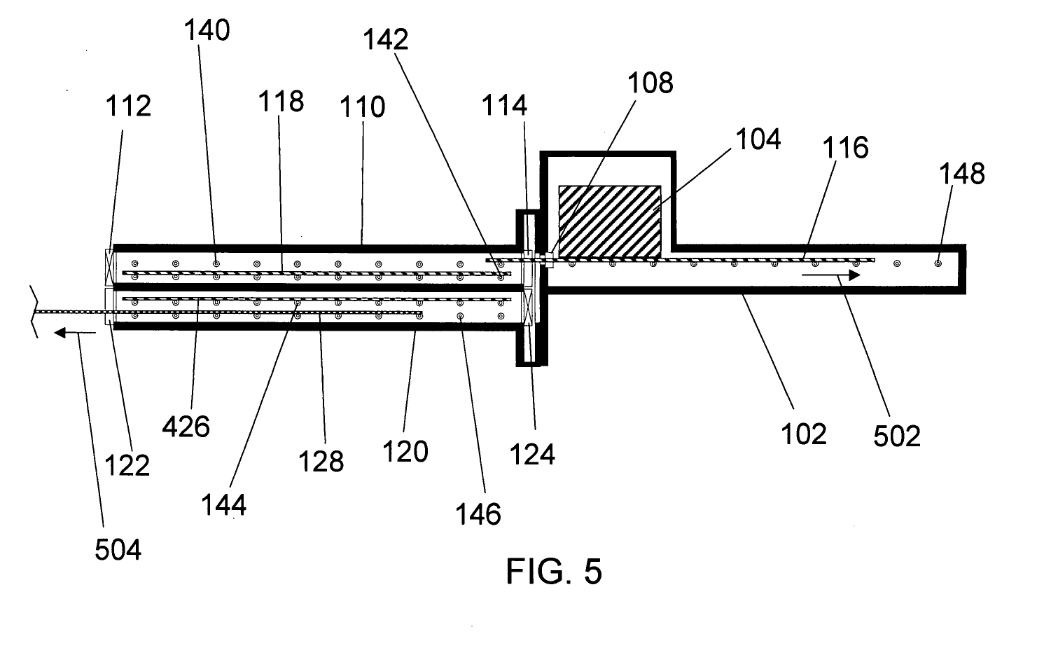

FIG. 5 shows the vacuum system at Time=35 s into the 240 s total operational cycle time. Substrate 116 is still being tested by column assembly 104 while moving (arrow 502) into processing chamber 102. Substrate 426 has been inserted into the upper slot in loadlock chamber #2 120 and now substrate 128 (which has already been tested) is being removed (arrow 504) through open valve 122 from the lower slot in loadlock chamber #2 120.

FIG. 6 shows the vacuum system at Time=45 s into the 240 s total operational cycle time. Substrate 116 has now been fully tested and is being removed (arrow 602) from processing chamber 102 (returning to the upper slot of loadlock chamber #1 110) by rollers 148, working in synchronism with rollers 140. Typically, substrate 116 would move at a much higher speed during removal from processing chamber 102 than the speed at which substrate 116 moved during testing (arrows 302, 402 and 502 in FIGS. 3-5, respectively). Substrate 128 has been fully removed from the lower slot in loadlock chamber #2 120, leaving room for substrate 428 to be inserted (arrow 604) into the lower slot of loadlock chamber #2 120.

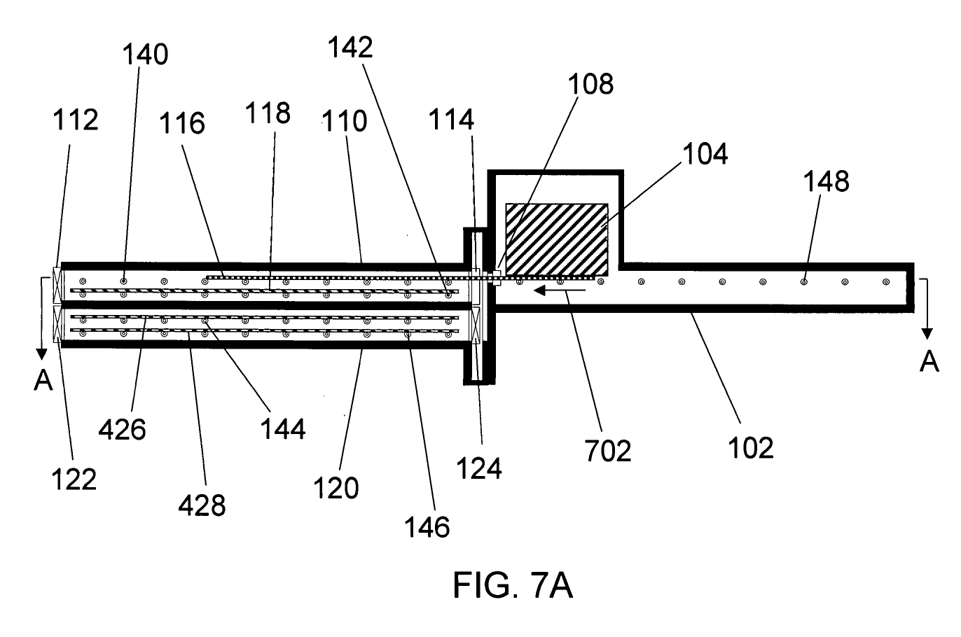

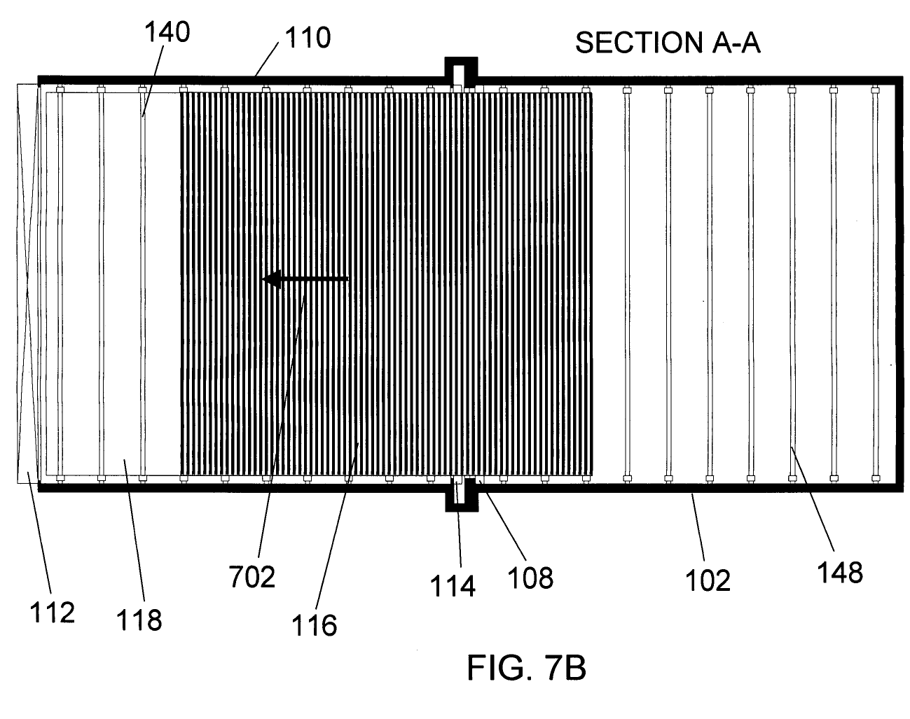

FIGS. 7A shows the vacuum system at Time=52 s into the 240 s total operational cycle time. Substrate 116 has almost been fully removed (arrow 702) from the processing chamber 102. Substrate 428 has been inserted into the lower slot in loadlock chamber #2 120. Valve 122 has closed and now loadlock chamber #2 120 is pumping down to the vacuum level in processing chamber 120.

FIG. 7B shows the vacuum system embodying the present invention in a schematic cross-sectional top view through section A-A in FIG. 7A, also at Time=52 s into the 240 s total operational cycle time. Substrate 116 can be seen moving (arrow 702) into the upper slot of loadlock chamber #1 110. Rollers 140 and substrate 118 (in the lower slot of loadlock chamber #1 110) can be seen at the left where they have not yet been obscured by substrate 116. Rollers 148 can be seen at the right where they are no longer obscured by substrate 116.

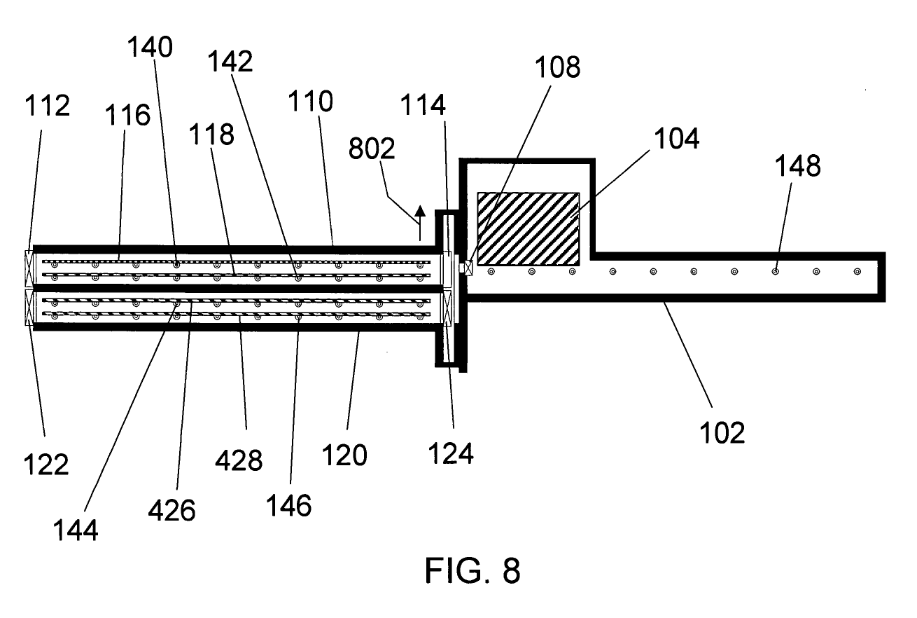

FIG. 8 shows the vacuum system at Time=57 s into the 240 s total operational cycle time. Substrate 116 has been returned to the upper slot of loadlock chamber #1 110. Valve 114 remains open as the loadlock assembly moves upward (arrow 802) to index the lower slot of loadlock chamber #1 110 to processing chamber 102. Loadlock chamber #2 120 continues pumping down to the vacuum level in processing chamber 102.

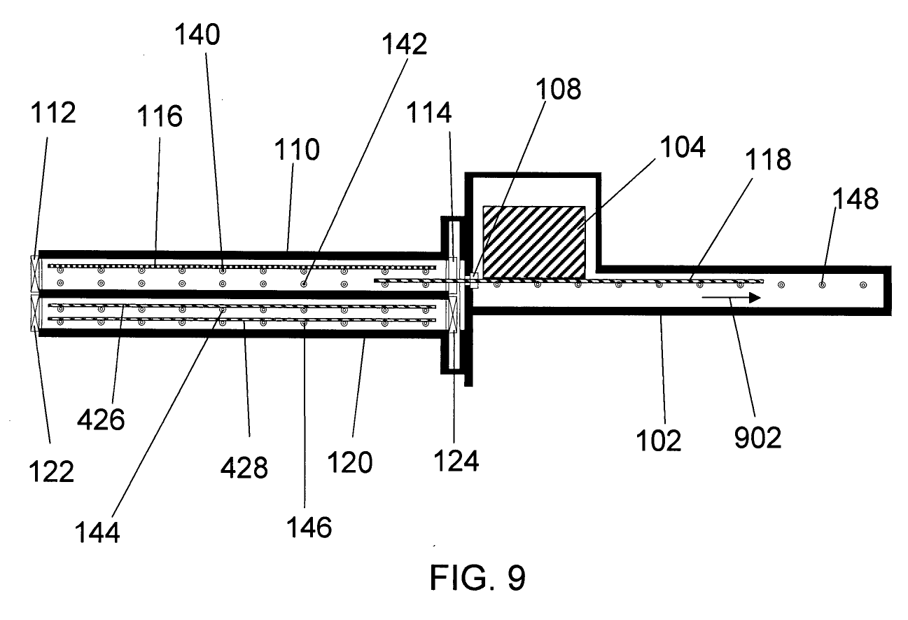

FIG. 9 shows the vacuum system at Time=90 s into the 240 s total operational cycle time. The loadlock assembly has been indexed to the lower slot in loadlock chamber #1 110. Substrate 118 is being tested by column assembly 104 during insertion (arrow 902) into processing chamber 102 by rollers 148, working in synchronism with rollers 142. Loadlock chamber #2 120 continues pumping down to the vacuum level in processing chamber 102.

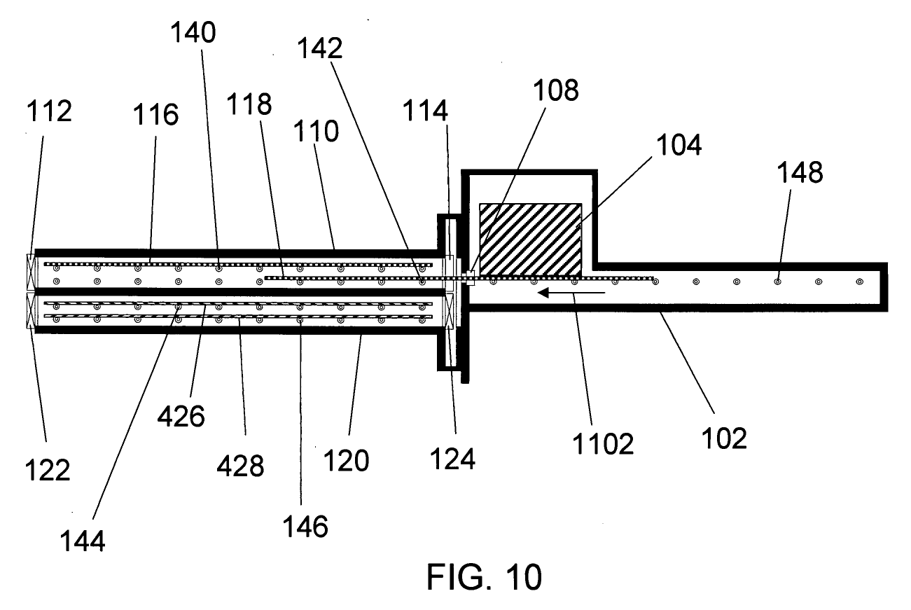

FIG. 10 shows the vacuum system at Time=110 s into the 240 s total operational cycle time. Substrate 118 has now been fully tested and is being removed (arrow 1102) from processing chamber 102 (returning to the lower slot of loadlock chamber #1 110) by rollers 148, working in synchronism with rollers 142. Loadlock chamber #2 120 continues pumping down to the vacuum level in processing chamber 102.

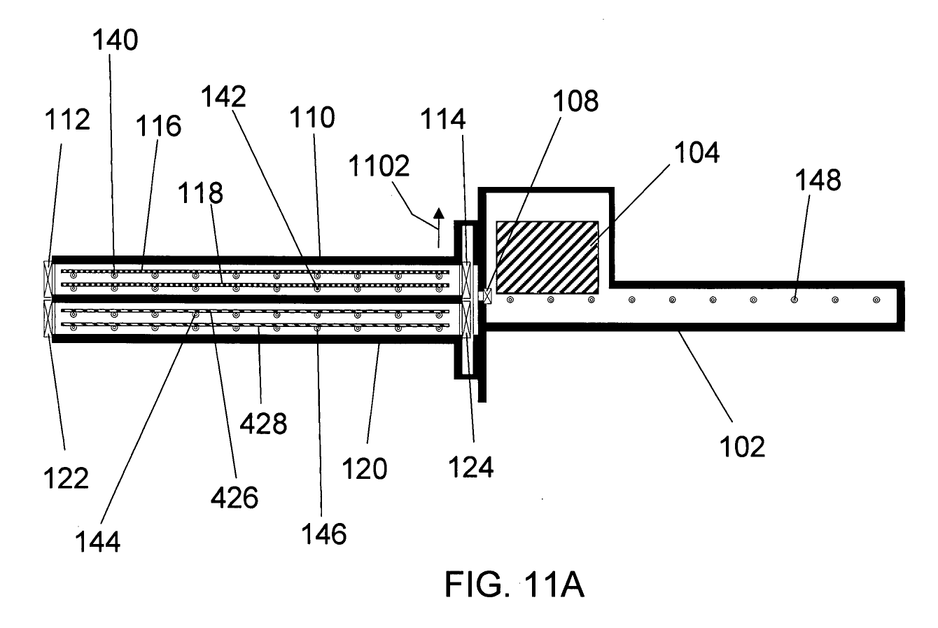

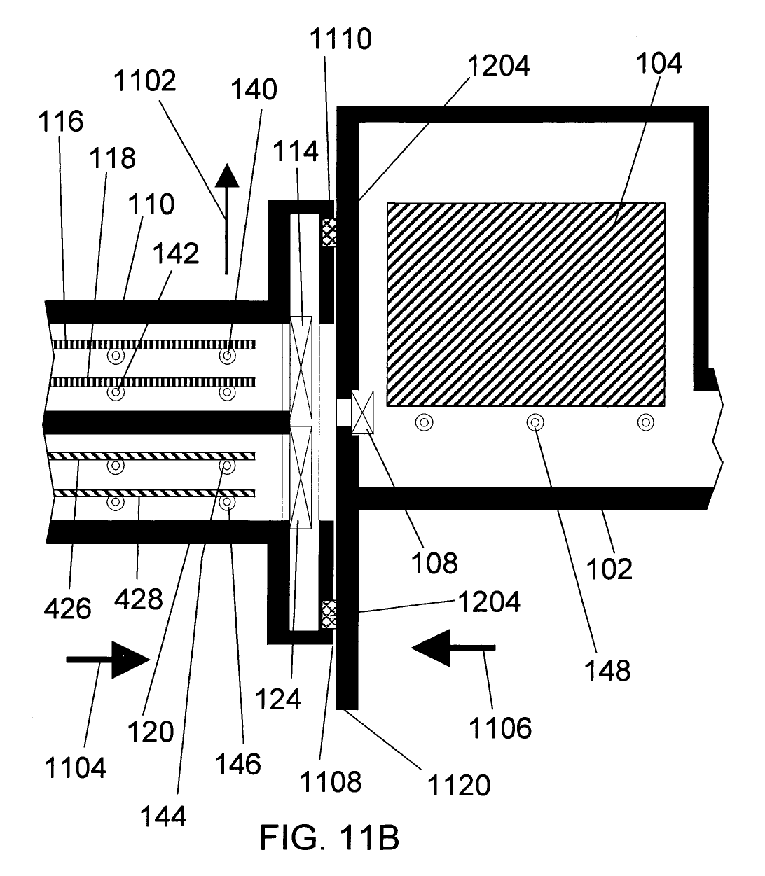

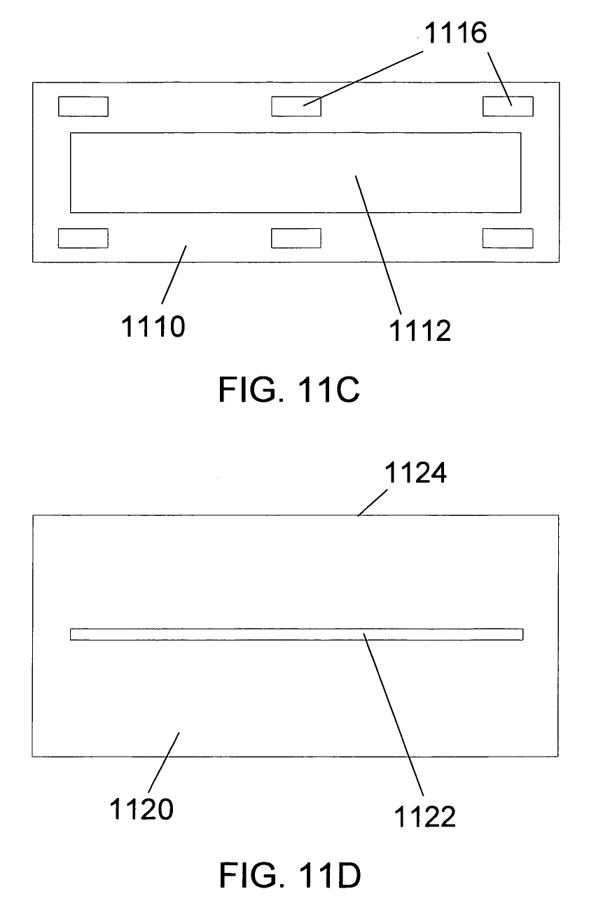

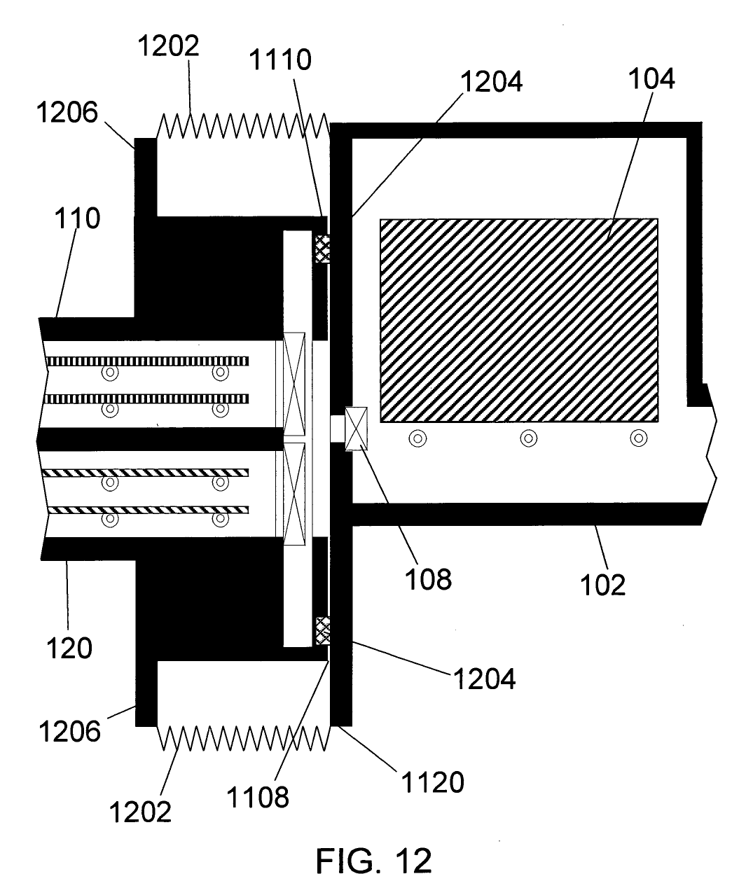

FIG. 11A shows the vacuum system at Time=117 s into the 240 s total operational cycle time. Substrate 118 is now in the lower slot of loadlock chamber #1 110. Valve 114 has closed and loadlock chamber #1 110 is being vented to atmospheric pressure (venting system not shown). Loadlock chamber #2 120 has been pumped down to the vacuum level in processing chamber 102. The loadlock assembly is moving upward (arrow 1102) to index the upper slot in loadlock chamber #2 120 to processing chamber 102.

FIG. 11B shows a close-up side cross-sectional schematic view of the interface between the loadlock assembly and the processing chamber 102 at Time=117 s in the operational cycle. Atmospheric pressure will exert a substantial force 1104, pushing the loadlock assembly to the right as shown. Atmospheric pressure will also exert a substantial force 1106, equal in magnitude to 1104, pushing the processing chamber 102 to the left as shown. Forces 1104 and 1106 must be opposed by a set of thrust bearings 1204 located between the loadlock assembly and processing chamber, in order to maintain a precise small gap 1108 between the loadlock assembly and the processing chamber. In the embodiment shown in FIG. 11B, the interface between the loadlock assembly and the processing chamber 102 is a moving vacuum seal wherein gap 1108 is maintained at a sufficiently small spacing to keep the gas leakage through gap 1108 at a level which can be adequately pumped (pumps not shown).

FIG. 11C is an end view of the loadlock assembly of FIG. 11B, showing the surface facing towards the processing chamber 102. Pockets 1116 are positioned at several locations across the annular flat surface 1110 in order to mount thrust bearings 1204 (see FIGS. 11B and 12). Opening 1112 allows passage of substrates (such as 118 in FIG. 10) into and out of the loadlock assembly.

FIG. 11D is an end view of the processing chamber 102 of FIG. 11B, showing the surface facing towards the loadlock assembly. Opening 1122 allows passage of substrates (such as 118 in FIG. 10) into and out of the processing chamber 102. The vacuum bellows 1202 (see FIG. 12) is attached with a vacuum seal to the outer perimeter 1124 of annular flat surface 1120.

FIG. 12 shows a schematic of a cross-section in a vertical plane of a bellows-sealed moving vacuum seal between the dual loadlock and the processing chamber. Bellows 1202 is shown attached at one end with a vacuum seal to the outer perimeter 1124 of annular flat surface 1120 of the processing chamber 102. The other end of bellows 1202 is attached with a vacuum seal to the outer perimeter of sealing wall 1206.

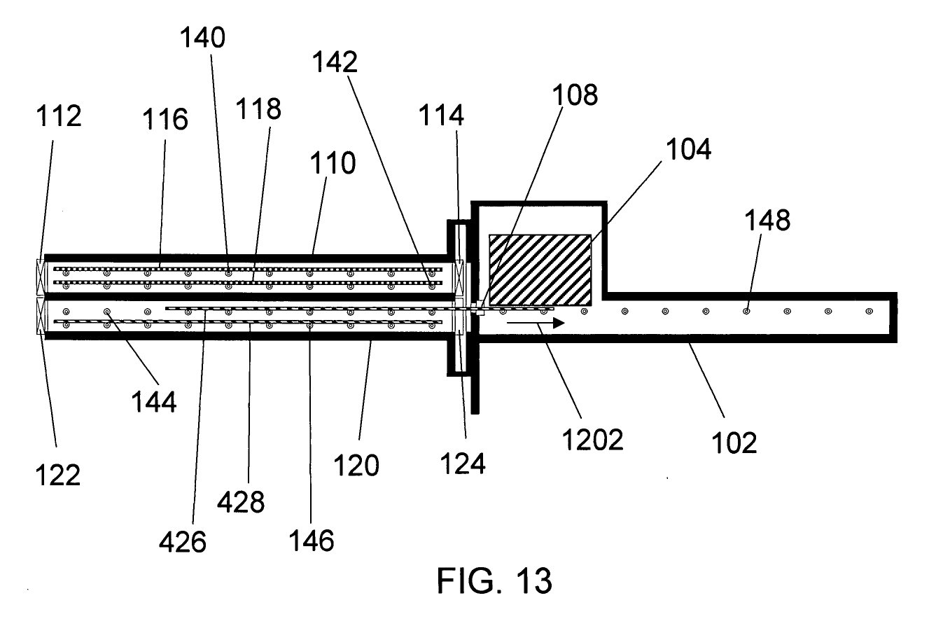

FIG. 13 shows the vacuum system at Time=124 s into the 240 s total operational cycle time—this corresponds to the situation in FIG. 2, except that the functions of the two loadlock chambers #1 110 and #2 120 are reversed. Valves 108 and 124 have opened to allow substrate 426 to be inserted (arrow 1202) into processing chamber 102 from loadlock chamber #2 120 by rollers 148, working in synchronism with rollers 144. Loadlock chamber #1 110 is venting to atmospheric pressure.

FIG. 14 shows the vacuum system at Time=155 s into the 240 s total operational cycle time—this corresponds to the situation in FIG. 5, except that the functions of the two loadlock chambers #1 110 and #2 120 are reversed. Substrate 426 is being tested by column assembly 104 while moving (arrow 1302) into processing chamber 102. Substrate 116 has been fully removed from the upper slot in loadlock chamber #1 110, leaving room for substrate 1326 to be inserted into the upper slot in loadlock chamber #1 110. Substrate 118 is being removed (arrow 1304) through open valve 112 from the lower slot in loadlock chamber#1 110.

FIG. 15 shows the vacuum system at Time=165 s into the 240 s total operational cycle time—this corresponds to the situation in FIG. 6, except that the functions of the two loadlock chambers #1 110 and #2 120 are reversed. Substrate 426 has now been fully tested and is being removed (arrow 1402) from processing chamber 102 (returning to the upper slot of loadlock chamber #2 120) by rollers 148, working in synchronism with rollers 144. Substrate 118 has been fully removed from the lower slot in loadlock chamber #1 110, leaving room for substrate 1318 to be inserted (arrow 1404) into the lower slot of loadlock chamber#1 110.

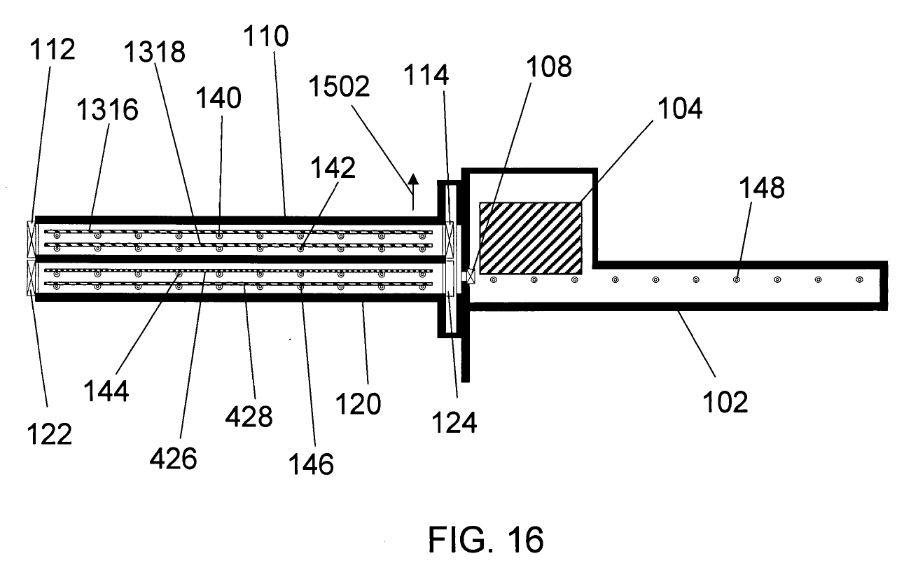

FIG. 16 shows the vacuum system at Time=177 s into the 240 s total operational cycle time—this corresponds to the situation in FIG. 8, except that the functions of the two loadlock chambers #1 110 and #2 120 are reversed. Substrate 426 has been returned to the upper slot of loadlock chamber #2 120. Valve 124 remains open as the loadlock assembly moves upward (arrow 1502) to index the lower slot of loadlock chamber #2 120 to processing chamber 102. Loadlock chamber #1 110 is pumping down to the vacuum level in processing chamber 102.

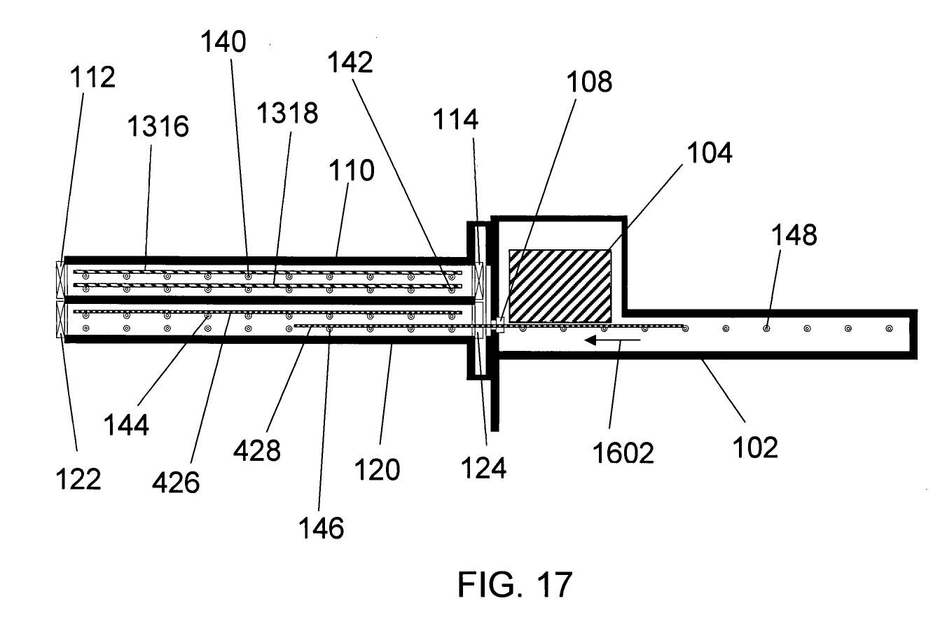

FIG. 17 shows the vacuum system at Time=230 s into the 240 s total operational cycle time—this corresponds to the situation in FIG. 10, except that the functions of the two loadlock chambers #1 110 and #2 120 are reversed. Substrate 428 has now been fully tested and is being removed (arrow 1602) from processing chamber 102 (returning to the lower slot of loadlock chamber #2 120) by rollers 148, working in synchronism with rollers 146. Loadlock chamber #1 110 continues pumping down to the vacuum level in processing chamber 102.

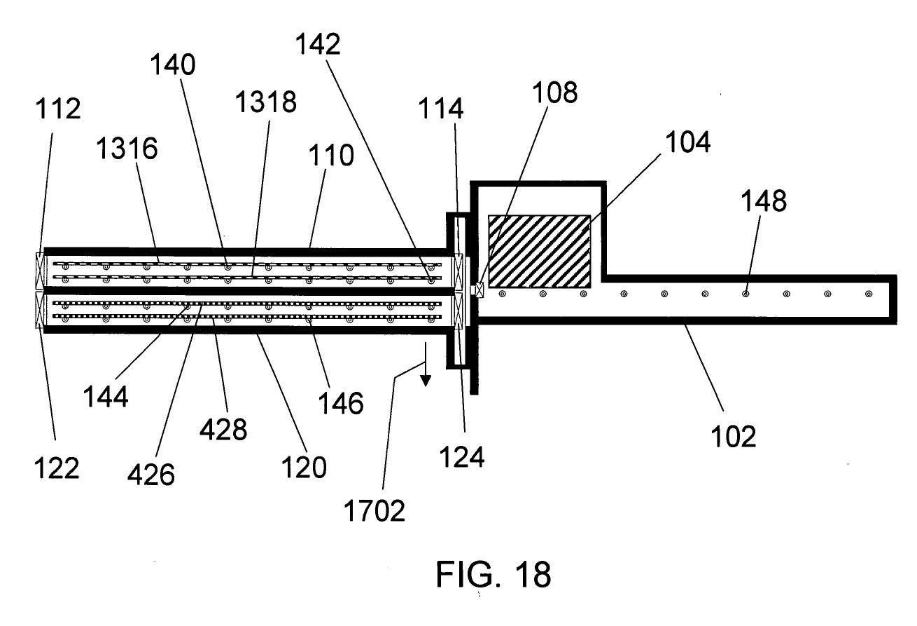

FIG. 18 shows the vacuum system at Time=237 s into the 240 s total operational cycle time—this corresponds to the situation in FIG. 11, except that the functions of the two loadlock chambers #1 110 and #2 120 are reversed. Substrate 428 is now in the lower slot of loadlock chamber #2 120. Valve 124 has closed and loadlock chamber #2 120 is being vented to atmospheric pressure (venting system not shown). Loadlock chamber #1 110 has been pumped down to the vacuum level in processing chamber 102. The loadlock assembly is moving downward (arrow 1702) to index the upper slot in loadlock chamber #1 110 to processing chamber 102. At Time=240 s, the vacuum system is returned to the status shown in FIG. 1 for Time=0 s.

The loadlock chambers 110 and 120 are assumed to be connected to pumping and venting manifolds, as is familiar to those skilled in the art. Venting systems typically consist of a number of valves, manifolds, and a supply of dry nitrogen—the same venting system can be used for both loadlock chambers 110 and 120, since only one of the loadlock chambers 110 and 120 is venting at any one time—for example, loadlock chamber #2 120 is venting in FIGS. 1-2, while loadlock chamber #1 110 is venting in FIG. 13. Pumpdown systems typically consist of a number of valves, manifolds, and pumps such as air ejectors, mechanical pumps, turbopumps, and/or cryopumps—the same pumping system can be used for both loadlock chambers 110 and 120, since only one of the loadlock chambers 110 and 120 is pumping down at any one time—for example, loadlock chamber #2 120 is pumping down in FIGS. 7A-10, while loadlock chamber #1 110 is pumping down in FIGS. 16-17.

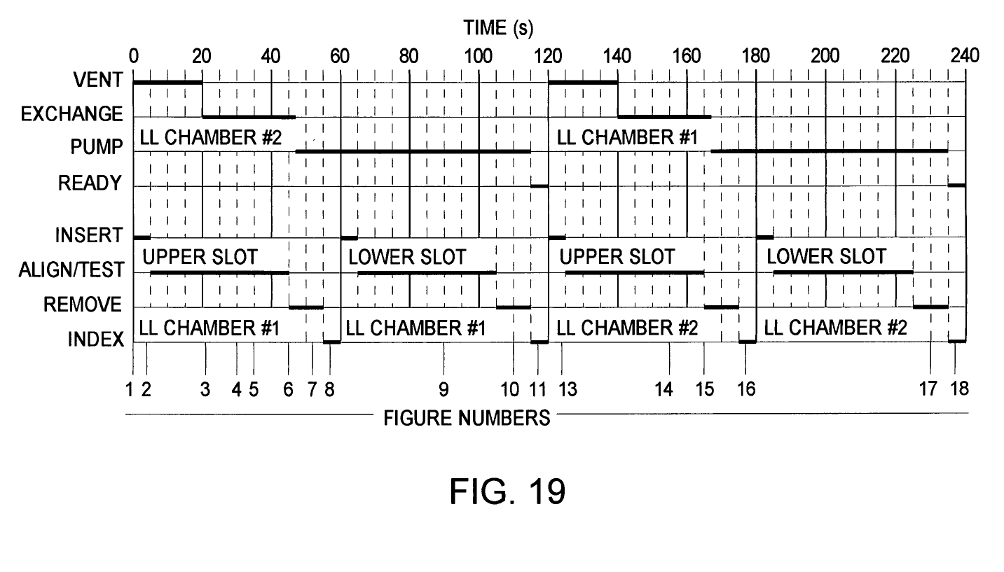

FIG. 19 shows a timeline of the 240 s operational cycle. The assumptions behind the pumping times in FIG. 19 are:

Loadlock chamber volume = 2800 L (each of chambers 110 and 120)
Pumping reservoir volume = 25600 L (not shown)

| Pumps: | 5 air ejectors and 4 | |
|---|---|---|
| | mechanical pumps (not shown) | |
| Total loadlock chamber | at 760 Torr | 1250 L/s |
| pumping speeds: | at 85 Torr | 127 L/s |
| | at 16 Torr | 300 L/s. |

Take the pumping of loadlock chamber #2 120 for example. At Time=50 s in FIG. 19, the pressure in loadlock chamber #2 120 is 760 Torr (atmospheric pressure)—at this point all 5 air ejectors and all 4 mechanical pumps are opened to the loadlock chamber #2 120 through valves (not shown), giving an initial pumping speed of 1250 L/s. The pumping speed of the air ejectors drops rapidly with lower chamber pressure, while the pumping speed of the mechanical pump increases more slowly, giving a minimum pumping speed of 125 L/s at 85 Torr. Below 85 Torr, the total pumping speed increases to 300 L/s at 16 Torr. At 16 Torr (at Time=110 s in FIG. 19), the loadlock chamber #2 120 is opened (through valves not shown) to the pumping reservoir (not shown), a large chamber (9× larger in volume than either of the loadlock chambers), which is initially at 1 Torr. The pressures of loadlock chamber #2 120 and the pumping reservoir equilibrate over a 5 s period at the final pressure of 2.5 Torr (at Time=115 s in FIG. 19), equal to the pressure in the processing chamber 102. After pressure equilibration, the pumping reservoir is sealed off from loadlock chamber #2 120 and is then pumped back down to 1 Torr in 90 s (from Time=115 s to 205 s in FIG. 19) to be ready for pumping of the loadlock chamber #1 110 as illustrated in FIG. 19.

The loadlock chambers are vented with dry nitrogen from a high capacity gas supply, with a supply pressure above atmospheric. With sufficiently large gas lines, the loadlock chambers can each be vented in about 20 seconds from 2.5 Torr up to 760 Torr with minimal turbulence which can deposit particles on the substrates.

The top four lines in FIG. 19 correspond to functions of the loadlock chambers #1 110 and #2 120:
1. Venting either of the loadlock chambers 110 or 120 from the vacuum level in the processing chamber 102 to atmospheric pressure. Venting is shown to take T_{Venting}=20 s (0-20 s for loadlock chamber #2 120 as shown in FIGS. 1-2 and 120-140 s for loadlock chamber #1 110 as shown in FIG. 13), which is a conservative value—in the preferred embodiment, venting is done slowly to reduce the generation of particles on the substrate by air turbulence.
2. Exchanging substrates from both the upper and lower slots in either of the loadlock chambers 110 or 120. Substrate exchange is shown to take T_{Exchange}=27 s (20-47 s for loadlock chamber #2 120 as shown in FIGS. 3-6 and 140-167 s for loadlock chamber #1 110 as shown in FIGS. 14-15). This may correspond to the sequential removal/insertion of N substrates (N=2 in FIGS. 1-19), or the simultaneous removal/insertion of N substrates. If N>1, substrates may be removed/inserted in groups of two, three, or more at a time for a total of N during the overall exchange time.

3. Pumping down either of the loadlock chambers 110 or 120 from atmospheric pressure to the vacuum level in the processing chamber 102. Pumpdown is shown to take T_{Pumping}=68 s (47-115 s for loadlock chamber #2 120 as shown in FIGS. 7A-10 and 167-235 s for loadlock chamber #1 110 as shown in FIS. 16-17). This pumpdown time was calculated on a detailed model of a preferred embodiment of the loadlock assembly and associated vacuum pumps.
4. Waiting for completion of substrate testing in the processing chamber 102—the “Ready” state. The ready state is shown to take 5 s (115-120 s for loadlock chamber #2 120 as shown in FIG. 11A and 235-240 s for loadlock chamber #1 110 as shown in FIG. 18)—the non-zero timing for the ready state shows that the turn-around cycle time is not limited by the loadlock cycle time.
   The bottom four lines in FIG. 19 correspond to functions of the processing chamber 102:
1. Insertion of a substrate from either the upper or lower slot in either of the loadlock chambers 110 or 120. Substrate insertion is shown to take T_{Insertion}=5 s (0-5 s for substrate 116—FIGS. 1-2, 60-65 s for substrate 118, 120-125 s for substrate 426—FIG. 13, and 180-185 s for substrate 428). The insertion time has been reduced by positioning the column assembly 104 near the entrance to processing chamber 102, as shown in FIGS. 1-18. This minimizes the insertion time since the insertion time=(travel distance from valve 108 to the side of column assembly 104 away from valve 108) (insertion speed).
2. Alignment of a substrate with the column assembly 104, followed by electron-beam Testing of the substrate using the column assembly 104. The time for both alignment and testing is shown to be T_{Alignment & Testing}=40 s (5-45 s for substrate 116—FIGS. 3-6, 65-105 s for substrate 118—FIG. 9, 125-165 s for substrate 426—FIGS. 14-15, and 185-225 s for substrate 428). Alignment involves the imaging of various alignment marks on the substrate in order to orient the electron beams emerging from the column assembly 104 with the pixel arrays on each liquid crystal display on the substrate. Testing involves the use of the electron beams produced by the column assembly 104 to simultaneously perform electrical testing on a number of pixels to determine if their functionality is within acceptable limits for a complete display. The 40 s alignment and testing time is based on electron optical modeling of the preferred embodiment of the column assembly, as described in U.S. Provisional Patent Application No. 60/608,609.
3. Removal of the substrate from the processing chamber after completion of testing into either the upper or lower slots in either of the loadlock chambers 110 or 120. Substrate removal is shown to take T_{Removal}=10 s (45-55 s for substrate 116—FIGS. 6-7A, 105-115 s for substrate 118—FIG. 10, 165-175 s for substrate 426—FIG. 15, and 225-235 s for substrate 428—FIG. 17). Removal takes longer than insertion (step 1, above) since the substrate must travel the entire length of processing chamber 102 to return to the loadlock assembly.
4. Indexing of the loadlock assembly with the processing chamber 102. Indexing is shown to take T_{Indexing}=5 s (55-60 s from the upper slot to the lower slot of loadlock chamber #1 110, 115-120 s from the lower slot of loadlock chamber #1 110 to the upper slot of loadlock chamber #2 120, 175-180 s from the upper slot to the lower slot of loadlock chamber #2 120, and 235-240 s from the lower slot of loadlock chamber #2 120 to the upper slot of loadlock chamber #1 110). For proper transfer of substrates between a particular slot in one of the two loadlock chambers #1 110 or #2 120, it is necessary to position the slot in the loadlock chamber relative to the processing chamber 102 so that substrates can move exactly horizontally back and forth as illustrated in FIGS. 2-7B, etc. This precise alignment process is called “indexing”. Indexing requires precise and repeatable positioning which can be accomplished using electric motors or pneumatic or hydraulic actuators, in combination with a means of precise position measurement such as optical encoders.

The total testing cycle time, T_{Testing Cycle}≡T_{Insertion}+T_{Alignment & Testing}+T_{Removal}+T_{Indexing}=60 s, while the total loadlock cycle time, T_{Loadlock Cycle}≡T_{Venting}+T_{Exchange}+T_{Pumpdown}=115 s, thus T_{Loadlock Cycle}/T_{Testing Cycle}=1.92→2. Consequently, in this example, the system may operate without delay due to the total loadlock cycle if N≧2, where N=the number of substrates which can be loaded into each loadlock chamber.

The invention described above requires some method of indexing the loadlock assembly to the opening in the processing chamber. Precise positioning of the loadlock assembly may be accomplished using a support mechanism which is capable of translating the entire loadlock assembly vertically in a precise and controlled manner (as shown by arrows 802, 1102, 1502, and 1702, in FIGS. 8, 11, 16, and 18, respectively). The support mechanism may employ geared electric motors, hydraulic cylinders, etc., but a key requirement is the ability to precisely move the loadlock assembly to the correct indexed position and then hold it at that position while substrate processing is completed.

Although the embodiment of the present invention shown herein contains two slots (each for one substrate) in each of two loadlock chambers, alternative embodiments may include three or more slots (each for one substrate) in each of two loadlock chambers. Additional embodiments might include more than two loadlock chambers, each containing at least one slot for a substrate. All embodiments require the use of indexing to sequentially position the loadlock assembly to a number of positions, each enabling insertion of a substrate to the proper position in the processing chamber, thus enabling proper functioning of the processing apparatus.

FIG. 19 shows that the venting of loadlock chambers #1 110 and #2 120 occurs at different times during the overall vacuum cycle, thus a single venting system is adequate for both loadlock chambers #1 110 and #2 120 of the loadlock assembly. Similarly, pumping of loadlock chambers #1 110 and #2 120 also occurs at different times during the overall vacuum cycle, thus a single loadlock pumping system is adequate for both loadlock chambers #1 110 and #2 120 of the loadlock assembly. The ability to employ single venting and pumping systems for the loadlock assembly represents a significant complexity, cost and reliability benefit for the vacuum system of the present invention.

The embodiment described herein shows (in FIG. 1) two substrates in each of loadlock chambers #1 110 and #2 120—depending on the loadlock cycle time, T_{Loadlock}, compared with the substrate testing time, T_{Testing}, N substrates (where N≧3) could be contained in each of loadlock chambers #1 110 and #2 120. As long as N>T_{Loadlock}/T_{Testing} (rounded up) the system will never wait for completion of the loadlock cycle and throughput will be determined solely by T_{Testing}. Although this embodiment illustrates the application of the present invention to the field of electron beam testing of flat panel substrates, the throughput analysis above is applicable to any type of processing for large substrates. Thus, in all the above calculations, T_{Testing} may be substituted by T_{Processing}, with no loss in generality.

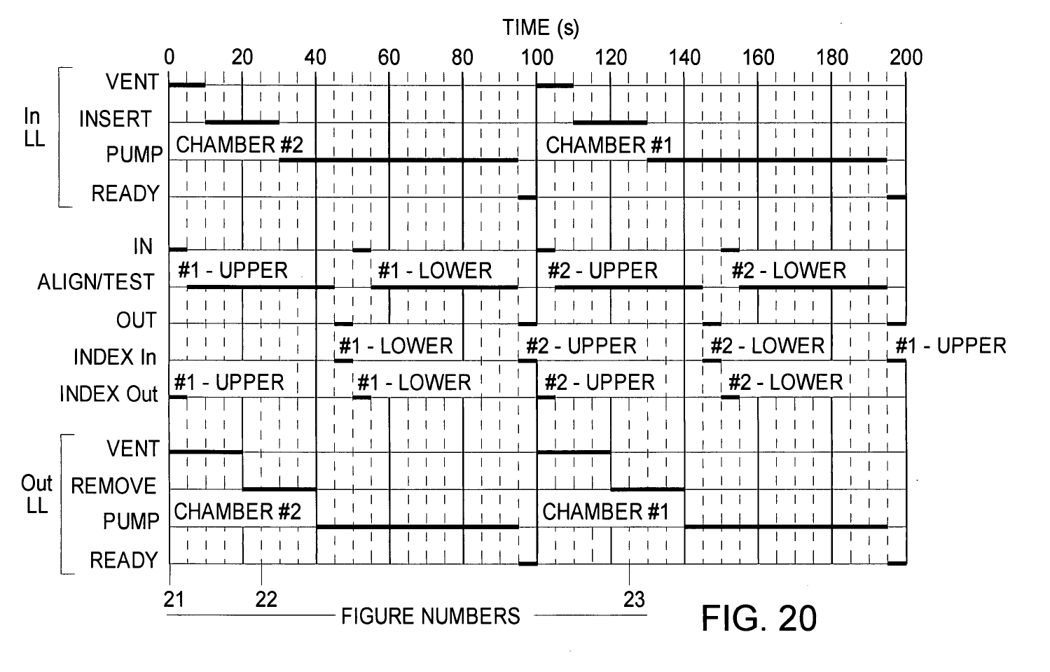

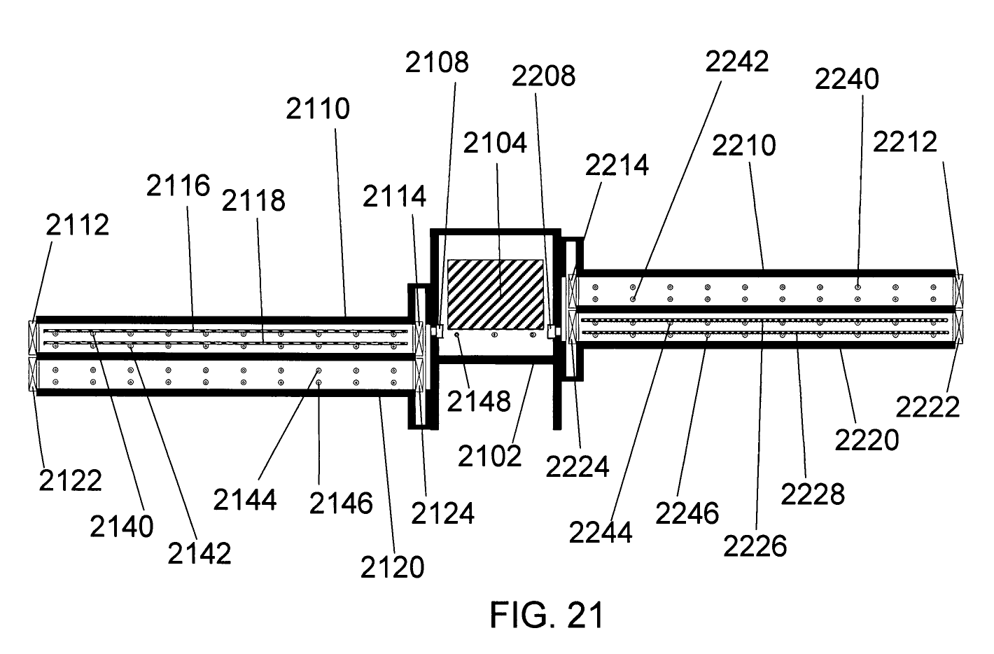

In some cases, it may be desirable to design the vacuum system with a “pass-through” configuration, wherein the substrates to be processed enter at one end of the tool, while processed substrates exit from the other end. For this alternative embodiment of the present invention, two loadlock assemblies (“input” and “output”) are required, as shown in FIG. 21. FIG. 20 shows a timeline of the 200 s operational cycle, which is 40 s shorter than the cycle shown in FIG. 19 because it is no longer necessary to remove the substrate from the processing chamber by reversing it out as illustrated in FIGS. 6, 7A, 7B, 10, 15, and 17.

The top four lines in FIG. 20 correspond to functions of the input loadlock assembly, comprising input loadlock chambers #1 2110 and #2 2120. Assumptions behind the timings for the steps in FIG. 20 are:
1. The “Vent” time is only 10 s since venting occurs with no substrates in the loadlock chambers, thus particulate generation is less of a concern and the venting process can be faster and more turbulent.
2. Instead of a substrate “Exchange” process taking 27 s in FIG. 19, FIG. 20 shows a substrate “Insert” process, since substrates are removed from the output loadlock assembly. The “Insert” time is 20 s (10-30 s for input loadlock chamber #2 2120 and 110-130 s for input loadlock chamber#1 2110).
3. The pump process is 65 s (30-95 s for input loadlock chamber #2 2120 and 130-195 s for input loadlock chamber #1 2110).
   The total input loadlock cycle time, T_{Input Loadlock Cycle}=95 s.

The center five lines correspond to functions of the processing chamber, in conjunction with both loadlock assemblies. Timings for the various steps are:
1. Substrate “In” is 5 s, as in FIG. 19.
2. Substrate “Align/Test” is 40 s as in FIG. 19—this is the same because the same substrate processing step is assumed for both FIGS. 19 and 20.
3. Substrate “Out” is 5 s—this is 5 s shorter than the “Remove” step in FIG. 19 because, in this case, the substrate need not reverse direction and travel the full length of the processing chamber.
4. Input loadlock assembly “Index In”—this step is in parallel with the “Substrate Out” step, since once the substrate being processed no longer extends back into the input loadlock assembly it is possible to index the loadlock assembly to position the next substrate for insertion into the processing chamber.
5. Output loadlock assembly “Index Out”—this step is in parallel with the “In” step, since during substrate insertion (prior to the beginning of “Align/Test”), there is no substrate extending between the processing chamber and the output loadlock assembly, thus the output loadlock assembly can be moved vertically to position the next (free) slot for insertion of the substrate just being inserted from the input loadlock assembly.
   The combination of these five steps (some in parallel) gives a total testing cycle time, T_{Testing Cycle 2}=50 s.

The bottom four lines in FIG. 20 correspond to functions of the output loadlock assembly, comprising output loadlock chambers #1 2210 and #2 2220. Timings for the various output loadlock steps are:
1. “Vent”—20 s the same as in FIG. 19, since processed substrates are in the output loadlock chambers 2210 and 2220 during venting, so minimizing particulate generation is important, requiring a less turbulent vent than is possible for the input loadlock chambers 2110 and 2120.
2. The substrate “Remove” step takes 20 s, as for the substrate “Insert” step in the input loadlock assembly.
3. The “Pump” step is 55 s, 10 s shorter than for the input loadlock chambers, thus requiring additional pumping—this is necessary to prevent the “Pump” step from limiting the overall tool cycle time.
   The total output loadlock cycle time, T_{Output Loadlock Cycle}=95 s. The input and output loadlock cycle times are the same, 95 s and we can define:
   T_{Loadlock Cycle 2}≡T_{Input Loadlock Cycle}=T_{Output Loadlock Cycle}
   Thus T_{Loadlock Cycle 2}≡/T_{Testing Cycle 2}=1.9→2. The dual loadlock assembly system may be operated without delay due to the input and output loadlock cycles if N≧2, where N=the number of substrates which can be loaded into each of the loadlock chambers in the input and output loadlock assemblies.

FIGS. 21 through 23 show cross-sectional schematic views of an alternative embodiment of the present invention with two loadlock assemblies, one for substrate input to the system, and one for substrate removal from the system. During the operational cycle shown in FIGS. 20-23, a total of four substrates 2116, 2118, 2250, and 2252 are tested using electron beams generated by the column assembly 2104, mounted in the processing chamber 2102. At the left of the processing chamber 2102 in FIGS. 21-23 is the input loadlock assembly, comprising input loadlock chambers #1 2110 and #2 2120, external valves 2112 and 2122, internal valves 2114 and 2124, and rollers 2140, 2142, 2144, and 2146. At the right of the processing chamber 2102 in FIGS. 21-23 is the output loadlock assembly, comprising output loadlock chambers. #1 2210 and #2 2220, external valves 2212 and 2222, internal valves 2214 and 2224, and rollers 2240, 2242, 2244, and 2246. The processing chamber 2102 comprises column assembly 2104, chamber seal-off valves 2108 and 2208, and rollers 2148.

Substrates from outside the vacuum system are inserted into input loadlock chamber #2 2120 through external valve 2122. Substrates located in input loadlock chamber #2 2120 are inserted into the processing chamber 2102 through internal valve 2124. Substrates being inserted into the upper slot of input loadlock chamber #1 2110, such as substrate 2116 in FIG. 21, are supported and moved by rollers 2140, driven by bi-directional motors (not shown). Similarly, substrates entering or leaving the upper and lower slots of loadlock chambers 2120, 2210, and 2220 are supported and moved by rollers 2144, 2146, 2240, 2242, 2244, and 2248.

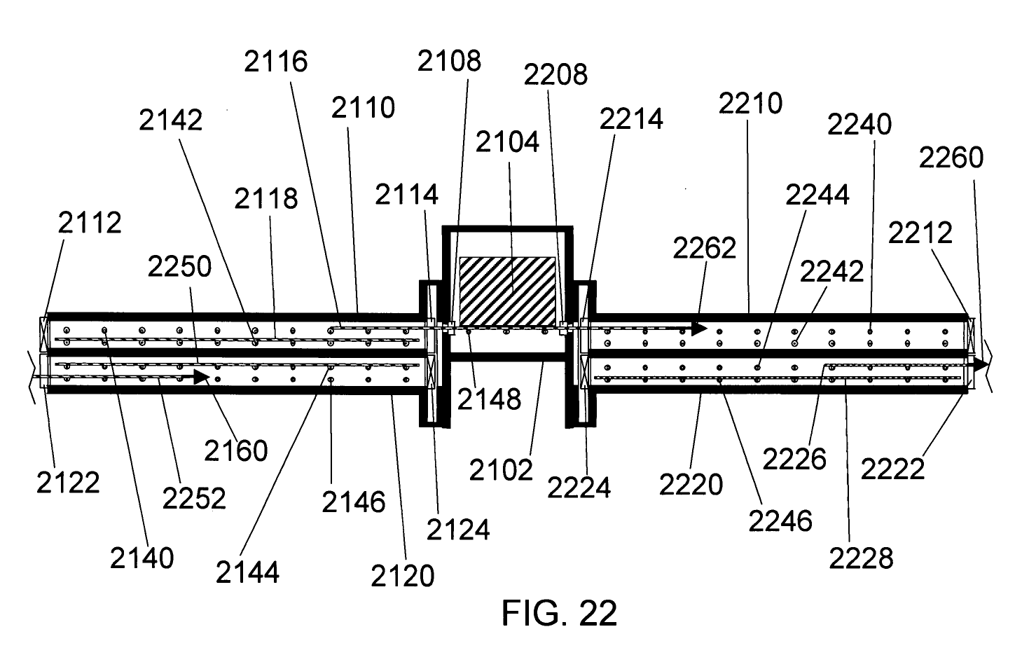

FIG. 21 shows the vacuum system of the second preferred embodiment at time=0 s into the 200 s total operational cycle time. Two unprocessed substrates 2116 and 2118 are shown within input loadlock chamber #1 2110 in the upper and lower slots, respectively. Both slots in input loadlock chamber #2 2120 are empty. Two processed substrates 2226 and 2228 are shown within output loadlock chamber #2 2220 in the upper and lower slots, respectively. Both slots in output loadlock chamber #1 2210 are empty. All eight valves 2112, 2122, 2114, 2124, 2214, 2224, 2212, and 2222 are initially closed (closed valves are shown schematically with an “X” inside the rectangular valve profile). The input loadlock assembly is positioned to index the upper slot in loadlock chamber #1 2110 with the processing chamber 2102, i.e., the upper slot in input loadlock chamber #1 2110 is aligned so that substrate 2116 can be moved horizontally by rollers 2140 into the processing chamber 2102 (see FIG. 22) with proper positioning under the column assembly 2104 for electron beam testing. The output loadlock assembly is positioned to index the lower slot in output loadlock chamber #2 2220 with the processing chamber 2102. Substrate 2228 has just been tested with the electron beam and then inserted into output loadlock chamber #2 2220.

FIG. 22 shows the vacuum system of the second preferred embodiment at time=25 s into the 200 s total operational cycle time. The output loadlock assembly has been indexed to position the upper slot in output loadlock chamber #1 2210 with the processing chamber 2102 to allow the substrate 2116 to continue moving horizontally (arrow 2262) out from under the column assembly 2104. Simultaneously with the electron beam testing of substrate 2116, an untested substrate 2252 is being inserted (arrow 2160) into the lower slot of input loadlock chamber #2 2120. The tested substrate 2226 is being removed (arrow 2260) from the upper slot of output loadlock chamber #2 2220.

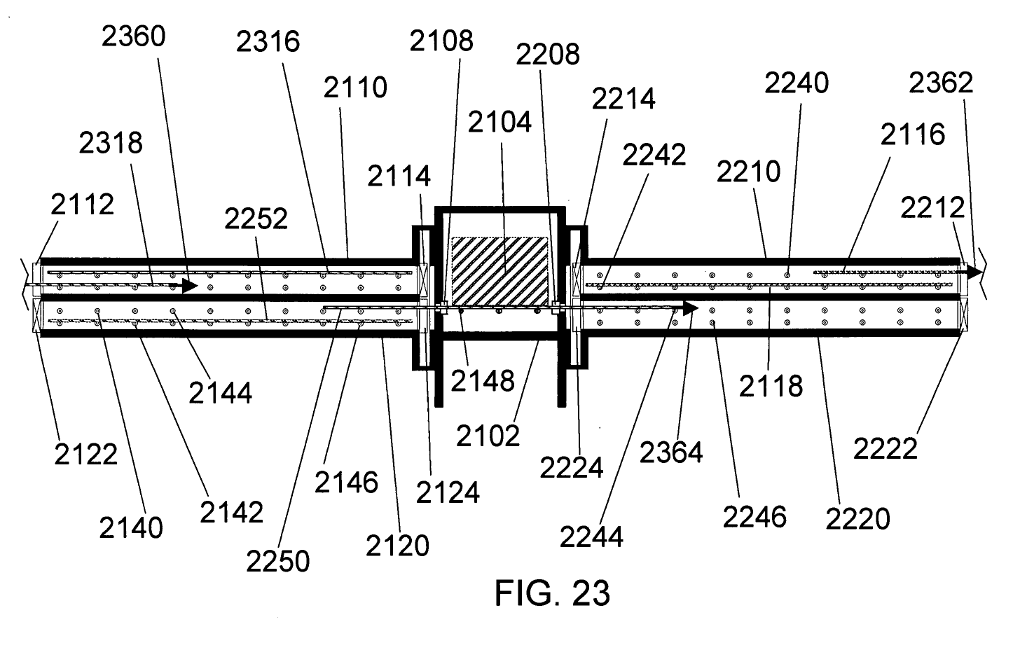

FIG. 23 shows the vacuum system of the second preferred embodiment at time=125 s into the 200 s total operational cycle time. The output loadlock assembly has been indexed to position the upper slot in output loadlock chamber #2 2220 with the processing chamber 2102 to allow the substrate 2250 to continue moving horizontally (arrow 2364) out from under the column assembly 2104. Simultaneously with the electron beam testing of substrate 2364, an untested substrate 2318 is being inserted (arrow 2360) into the lower slot of input loadlock chamber #1 2110. The tested substrate 2116 is being removed (arrow 2362) from the upper slot of output loadlock chamber #1 2210.

The path followed by a substrate through the loadlocks and processing system is referred to herein as a feedpath. The feedpath connects and includes a sequence of storage and processing positions which a particular substrate occupies from initial insertion into the tool to removal from the tool. As an example, the feedpath for substrate 116 in FIGS. 1-13 includes the following positions:
1. Upper slot of loadlock chamber #1 110 (FIG. 1)
2. Processing chamber 104 (FIGS. 2-7B)
3. Upper slot of loadlock chamber #1 110 (FIGS. 8-13)
   Similar feedpaths can be defined for the second embodiment of the present invention, for example, the feedpath for substrate 2118 in FIGS. 21-23 includes the following positions:
1. Lower slot of input loadlock chamber #1 2110
2. Processing chamber 2104
3. Lower slot of output loadlock chamber #1 2210

The loadlock chambers 2110 and 2120 are assumed to be connected to pumping and venting manifolds, as is familiar to those skilled in the art. Venting systems typically consist of a number of valves, manifolds, and a supply of dry nitrogen—the same venting system can be used for both input loadlock chambers 2110 and 2120, since only one of the input loadlock chambers 2110 and 2120 is venting at any one time. Pumpdown systems typically consist of a number of valves, manifolds, and pumps such as air ejectors, mechanical pumps, turbopumps, and/or cryopumps—the same pumping system can be used for both input loadlock chambers 2110 and 2120, since only one of the input loadlock chambers 2110 and 2120 is pumping down at any one. Similar considerations apply to the output loadlock chambers #1 2210 and #2 2220—the same venting and pumping systems can be used for both, however, different pumping and venting systems are required for the input and output loadlock assemblies since the pump and vent cycles are in parallel.

For certain applications, it is desirable to delay starting to process a substrate until it is completely inside the processing chamber, allowing the processing chamber seal-off valve to be closed to isolate the processing chamber from the loadlock assembly. In this case, the processing chamber 2102 in FIGS. 21-23 would necessarily be longer than the substrate. Applications having this vacuum isolation requirement might typically involve the generation of a plasma within the processing chamber, for use in plasma-enhanced chemical vapor deposition or for physical vapor deposition of thin films on the surfaces of large substrates.

In an alternative embodiment of the present invention (not shown), the substrates are held in a vertical orientation, both in the slots within each loadlock chamber, as well as within the processing chamber. In this case, the loadlock chambers are mounted side-by-side and the indexing of the loadlock chambers involves a precise horizontal motion. Substrate motions in this arrangement are still in a horizontal plane. Note that in this embodiment the port is a vertical slot and the transport of substrates is handled by mechanisms adapted for transport of vertically oriented substrates, as known to those skilled in the art.

Although the first and second embodiments have illustrated the application of the present invention to the electron beam testing of flat panel substrates, various other processes and or substrate types could also benefit from the increased throughput of this invention, such as: deposition of coatings on large sheets of glass for thermally-insulating windows; ceramic sheets; printed circuit boards; large crystalline or amorphous silicon sheets such as those used in the manufacture of solar cells, etc.

The preferred embodiments illustrate the present invention without the use of a robot, however, an alternative embodiment would involve the use of the present invention in applications where the use of a robot with a vertical travel is not possible or is undesirable—in these applications, the loadlock assembly would index to the plane of the robot motion, thereby enabling the robot to access any of the substrates within the loadlock assembly. This could be beneficial for any substrate processing application for which loadlock vent/exchange/pumpdown cycles are long, thus requiring that a large number of substrates be loaded within the loadlock assembly to achieve the desired balance between the loadlock cycle time and the total processing time.

Another application of the present invention could be to processing systems which do not require a vacuum in the processing chamber, but, rather, require some type of (non-air) processing gas at a pressure near atmospheric. One example would be atmospheric pressure chemical vapor deposition, for which the benefit of the present invention is increased throughput, since with proper balancing of the loadlock cycle time and the processing time, the tool need never wait for completion of the loadlock cycle before proceeding to the processing of the next substrate.

The first embodiment has illustrated the present invention using five sets of bi-directional motor-driven rollers 140, 142, 144, 146, and 148 (see FIG. 1), while the second embodiment has illustrated the present invention using nine sets of bi-directional motor-driven rollers 2140, 2142, 2144, 2146, 2148, 2240, 2242, 2244, and 2246 (see FIG. 21); however, other transport mechanisms may also be employed. One example would be bi-directional motor-driven belts extending along the substrate travel axes (such as arrow 102 in FIG. 2), and positioned underneath the various substrates within the loadlock chambers 110 and 120, as well as within the processing chamber 102. Another possibility would be bidirectional motor-driven rollers along each side of the substrates, but not extending underneath the substrates—this embodiment would be applicable for substrates which are stiff enough not to require support across their width (along the direction perpendicular to the motion axis, such as arrow 202 in FIG. 2).

Although the two embodiments of the present invention shown in FIGS. 1-17 and FIGS. 21-23 show the orientation of the substrates to be horizontal, it is possible to make changes to the transport mechanisms and orientation of other components, as will be apparent to those skilled in the art, in order to accommodate substrates held vertically. Furthermore, the loadlock chambers may be positioned either beside each other or one above the other, and both of these configurations can be set-up for substrates held either horizontally or vertically. Note that when the substrates are held vertically and the loadlocks are positioned one above the other, then the loadlocks move vertically to index with the port and then for indexing of subsequent substrates, within one loadlock, the loadlock moves horizontally. Also note that when the substrates are held horizontally and the loadlocks are positioned beside each other, then the loadlocks move horizontally to index with the port and then for indexing of subsequent substrates, within one loadlock, the loadlock moves vertically.

In another embodiment of the present invention, a group of substrates may be transferred simultaneously into a processing system from a first loadlock chamber. After the group of substrates is processed, they may be transferred back to the loadlock chamber. In this embodiment, a second group of substrates would be pumped down in a second loadlock chamber during the processing of the first group of substrates. After the first group has been returned to the first loadlock chamber, the loadlock chambers would move to position the second loadlock chamber to insert the second group into the processing chamber. This procedure would continue for a group of L loadlock chambers, each containing M substrates. The values of L and M would be determined by a similar calculation to that given for N in the preferred embodiments herein.

1. A system for processing of large substrates, comprising:
a processing chamber including a port configured to accommodate passage of one of said large substrates; and
a loadlock assembly coupled to said processing chamber, said loadlock assembly being configured to accommodate a multiplicity of said large substrates;
wherein said processing chamber and said loadlock assembly are configured to move relative to each other to allow positioning of any one of said multiplicity of said large substrates for passage through said port.

2. A system as in claim 1, wherein said loadlock assembly comprises a multitude of loadlock chambers.

3. A system as in claim 2, wherein said processing chamber and said loadlock assembly are configured to move relative to each other to allow alignment of any one of said multitude of loadlock chambers with said port.

4. A system as in claim 2, wherein said multitude of loadlock chambers is two loadlock chambers.

5. A system as in claim 2, wherein said loadlock chambers are positioned one above another, and wherein said loadlock assembly and said processing chamber are configured to move in a vertical direction relative to each other.

6. A system as in claim 2, wherein said loadlock chambers are positioned beside each other, and wherein said loadlock assembly and said processing chamber are configured to move in a horizontal direction relative to each other.

7. A system as in claim 2, wherein each of said loadlock chambers comprises:
a vacuum enclosure configured to contain at least one of said large substrates;
an external valve configured to accommodate passage of at least one of said large substrates into and out of said loadlock chamber; and
an internal valve configured to accommodate passage of said large substrates, one at a time, through said port.

8. A system as in claim 7, wherein each of said loadlock chambers further comprises a plurality of bidirectional motor-driven rollers configured to support said at least one of said substrates within said loadlock chamber and to assist in moving said at least one of said substrates into and out of said loadlock chamber.

9. A system as in claim 1 further comprising a moving vacuum seal positioned between said processing chamber and said loadlock assembly and wherein said loadlock chambers and said processing chamber are vacuum chambers.

10. A system as in claim 9, wherein said moving vacuum seal comprises:
a first annular flat surface on a side of said loadlock assembly facing said processing chamber; and
a second annular flat surface on a side of said processing chamber facing said loadlock assembly, said second annular flat surface being directly opposed to and held in close proximity to said first annular flat surface.

11. A system as in claim 10, wherein said moving vacuum seal further comprises a metal bellows vacuum sealed at a first end to said loadlock assembly and at a second end to said processing chamber.

12. A system as in claim 10 wherein the spacing between said first and second annular flat surfaces is maintained by a plurality of thrust bearings interposed between said loadlock assembly and said processing chamber.

13. A system as in claim 1 wherein said processing chamber contains a multiple electron beam column assembly for testing of said large substrates.

14. A system as in claim 1, wherein said large substrates are flat panel display substrates.

15. A system as in claim 1, wherein said large substrates are formed of glass, silicon or ceramic.

16. A system for processing of large substrates, comprising:
a processing chamber including a port configured to accommodate passage of a multiplicity of said large substrates; and
a loadlock assembly coupled to said processing chamber, said loadlock assembly including a multitude of loadlock chambers, each of said multitude of loadlock chambers being configured to accommodate said multiplicity of said large substrates;
wherein said processing chamber and said loadlock assembly are configured to move relative to each other to allow alignment of any one of said multitude of loadlock chambers with said port.

17. A system for processing of large substrates, comprising:
a processing chamber including an input port and an output port, each configured to accommodate passage of one of said large substrates;
an input loadlock assembly coupled to said processing chamber, said loadlock assembly being configured to accommodate a multiplicity of said large substrates; and
an output loadlock assembly coupled to said processing chamber, said loadlock assembly being configured to accommodate a multiplicity of said large substrates;
wherein said input loadlock assembly is configured to move relative to said processing chamber to allow positioning of any one of said multiplicity of said large substrates for passage through said input port, and said output loadlock assembly is configured to move relative to said processing chamber to allow insertion through said output port of one of said multiplicity of said large substrates into an unoccupied slot.

18. A system as in claim 17, wherein said input loadlock assembly comprises a multitude of loadlock chambers.

19. A system as in claim 18, wherein said processing chamber and said input loadlock assembly are configured to move relative to each other to allow alignment of any one of said multitude of loadlock chambers with said input port.

20. A system as in claim 17, wherein said output loadlock assembly comprises a multitude of loadlock chambers.

21. A system as in claim 20, wherein said processing chamber and said output loadlock assembly are configured to move relative to each other to allow alignment of any one of said multitude of loadlock chambers with said output port.
